(19) United States
(12) Patent Application Publication
(10) Pub. No.: US 2020/0219150 A1
(43) Pub. Date: Jul. 9, 2020

(54) METHOD AND SYSTEM FOR A VALUE BASED ATTESTATION OF COUNTERPARTY CREDIBILITY

(71) Applicant: Dallas Johnston, Tokyo (JP)

(72) Inventor: Dallas Johnston, Tokyo (JP)

(21) Appl. No.: 16/275,127

(22) Filed: Feb. 13, 2019

Related U.S. Application Data
(60) Provisional application No. 62/629,827, filed on Feb. 13, 2018.
(60) Provisional application No. 62/629,827, filed on Feb. 13, 2018.

(51) Int. Cl. G06Q 30/02

(52) U.S. Cl. CPC G06Q 30/0282

(57) ABSTRACT

The present invention is a method of attesting to the credibility of counterparties comprising; creating, an account, associating, personal identification information to the account, assigning, a limiter value based on the type of personal identification information associated with the account, receiving, a request from a voucher to attest to an entity's credibility, wherein the voucher has a documented prior engagement or verifiable connection with the counterparty, assigning, the voucher to attest to the entity, wherein the assignment a first portion of a tokenized asset, wherein the tokenized asset is associated with the voucher, receiving, a rating by a third party of an engagement between the third party and the entity, analyzing, the rating of the entity by the third party, and adjusting, the first portion of the tokenized asset associated with the voucher with a second portion of the tokenized asset based on the analyzed rating of the third party.

### CROSS-REFERENCE TO RELATED APPLICATIONS

This application is a continuation-in-part (and claims the benefit of priority under 35 USC 120) of U.S. application No. 62/629,827 filed Feb. 13, 2018 and U.S. application No. 62/675,4100 filed on May 23, 2018. The disclosure of the prior applications is considered part of (and is incorporated by reference in) the disclosure of this application.

### BACKGROUND

This disclosure relates generally to an attestation system and method, and more specifically to a method, computer program and computer system for value-backed vouching for entity credibility as these entities seek to engage in commerce, trade or lending activity with third parties.

Trust and credibility form the foundation of trade, commerce and finance. At the core of trust is credibility. There is no universal formula for establishing credibility, because systems of credibility are by nature fluid and responsive to advancements in technologies which enhance counterparty transparency and accountability.

With the advent of internet based, socially sourced consumer opinion platforms like Yelp™, Angie's List™, Google Reviews™, and Facebook Business™, individuals now have at their disposal powerful signals that increasingly inform their purchasing and patronage decisions. These signals are furthermore embodying a new-found convention for credibility, catalyzing a rapid shift in consumer behavior from sole dependence on informal “word-of-mouth” insights limited in scope only to the scattered signals of one's immediate social or business networks—to deepening reliance upon a social web of “electronic” word-of-mouth platforms.

However successful these systems have been in establishing a new baseline for credibility, they are proving far from ideal as research is indicating inherent vulnerability to fraud, with consumers growing increasingly wary of tactics employed by listed entities to game the system.

According to some studies, 20% of online reviews are fraudulent, with companies seeking to bury negative feedback through prompted or even paid-for reviews.

Existing reputation systems are susceptible to fraud due to the centralized, opaque nature of third-party consumer opinion platforms; unfair/false positive algorithmic filtering or prioritized search ranking due to misaligned economic interests of for-pay listing or advertising services; negative review skew, as customers with poor experiences are more likely to vocalize their disapproval than those with positive ones; positive review/rate biases resulting from company prompts (email, messaging apps, etc.), outright manipulation through customer review incentive programs bereft of individual accountability protocols—i.e. no risk, all reward; social influence bias, where social signals exert overly influential forces on reviewer sentiment; and insufficient representation of the full history of engagement, as post-purchase review engagement rates are estimated at only 2˜5%, thus distorting the vendor profile.

Additionally, current credit rating systems attempt to establish financial credibility, or creditworthiness, of borrowers based upon several factors that often exclude large percentages of loan applicants from access to credit facilities, for instance the self-employed or those lacking sufficient collateral or traditional credit histories, regardless of their actual ability to service debt. Compounding this issue, there is no single standard for determining creditworthiness of potential borrowers, leading to arbitrary, confusing and often times conflicting credit scoring results.

Therefore, it is desired for a method, computer program, or computer system to address the flaws inherent to existing systems for establishing counterparty reputation or creditability in commerce and lending by designing a credibility attestation system wherein entities can vouch for transactional counterparties by staking value on their engagements, incentivizing participants to accurately represent entity credibility and deterring fraudulent behavior to the betterment of all economies involved.

### SUMMARY

In a first embodiment, the present invention is a method of attesting to the credibility of entities engaged in commerce and trade, utilizing a value-staked vouching mechanism wherein backing positive outcomes results in economic rewards for attesters and, conversely, backing negative outcomes results in economic penalties for the same, the method comprising: creating, by one or more processors, account for all participants on a distributed and cryptographically secure ledger, identified by a unique account name, number, key or address; attaching, by one or more processors, at least one personally identifiable information datum to the account; assigning, by one or more processors, a limiter value based on the type of the at least one personally identifiable information datum having been associated with the account; receiving, by one or more processors, a request from a voucher account to attest to or stake on an entity's credibility, wherein the voucher account has a documented prior economic engagement with the entity; assigning, by one or more processors, the voucher account to attest to or stake on the credibility of the entity, wherein the assignment allocates a portion of at least one tokenized asset associated with the voucher account; receiving, by one or more processors, a rating by a third party of the entity's activity; analyzing, by one or more processors, the rating of the entity; and adjusting, by one or more processors, the quantity or balance of the tokenized asset associated with the voucher account, reflecting the rating of the entity engagement, with the amount of positive adjustment being bounded by the account limiter.

In a second embodiment, the present invention is a method of attesting to the creditworthiness of entities engaged in borrowing, utilizing a stake-based collateralization or insurance mechanism wherein backing borrowers that service loans according to contractual repayment terms results in economic rewards for attesters and, conversely, backing borrowers that fail to service loans according to contractual obligations results in the backers' collateral being remitted to the lender as a form of redress, the method comprising: creating, by one or more processors, accounts for all participants on a distributed and cryptographically secure ledger, identified by a unique account name, number, key or address; associating, by one or more processors, at least one personally identifiable information datum to the account; assigning, by one or more processors, a limiter value based on the type of the at least one personally identifiable information datum having been associated with the account; receiving, by one or more processors, a request from an attester account to collateralize an entity's loan, wherein the attester account has expressed intent to post collateral on behalf of a borrowing entity; assigning, by one or more processors, the attester account to collateralize or insure the entity's loan, wherein the assignment allocates at least one tokenized asset owned by the attester account; receiving, by one or more processors, evidence of success or failure to service the loan obligation by the debtor; and apportioning, by one or more processors, an amount out of the loan interest to the attester's account in the case of timely servicing of the loan by the debtor or remitting the attester's stake-based collateral to the creditor in the instance that the borrower defaults on the loan.

In a third embodiment, the present invention is a computer program product for attesting to the credibility of entities engaged in commerce and trade, utilizing a value-staked vouching mechanism wherein backing positive outcomes results in economic rewards for attesters and, conversely, backing negative outcomes results in economic penalties for the same, the computer program product comprising: one or more computer readable storage media and program instructions stored on the one or more computer readable storage media, the program instructions comprising: program instructions for creating accounts for all participants on a distributed and cryptographically secure ledger, identified by a unique account name, number, key or address; program instructions to attach at least one personally identifiable information datum to the account; program instructions to assign a limiter value based on the type of the at least one personally identifiable information datum having been associated with the account; program instructions to receive a request from a voucher account to attest to or stake on an entity's credibility, wherein the voucher account has a documented prior economic engagement with the entity; program instructions to assign the voucher account to attest to or stake on the credibility of the entity, wherein the assignment allocates a portion of at least one tokenized asset associated with the voucher account; program instructions to receive a rating by a third party of the entity's activity; program instructions to analyze the rating of the entity; and program instructions to adjust the quantity or balance of the tokenized asset associated with the voucher account, reflecting the rating of the entity engagement, with the amount of positive adjustment being bounded by the account limiter.

In a fourth embodiment, the present invention is a computer system for attesting to the credibility of entities engaged in commerce and trade, utilizing a value-staked vouching mechanism wherein backing positive outcomes results in economic rewards for attesters and, conversely, backing negative outcomes results in economic penalties for the same, the computer system comprising: one or more computer processors, one or more computer readable storage media, and program instructions stored on the one or more computer readable storage media for execution by, at least one of the one or more processors, the program instructions comprising: program instructions for creating accounts for all participants on a distributed and cryptographically secure ledger, identified by a unique account name, number, key or address; program instructions to attach at least one personally identifiable information datum to the account; program instructions to assign a limiter value based on the type of the at least one personally identifiable information datum having been associated with the account; program instructions to receive a request from a voucher account to attest to or stake on an entity's credibility, wherein the voucher account has a documented prior economic engagement with the entity; program instructions to assign the voucher account to attest to or stake on the credibility of the entity, wherein the assignment allocates a portion of at least one tokenized asset associated with the voucher account; program instructions to receive a rating by a third party of the entity's activity; program instructions to analyze the rating of the entity; and program instructions to adjust the quantity or balance of the tokenized asset associated with the voucher account, reflecting the rating of the entity engagement, with the amount of positive adjustment being bounded by the account limiter.

### BRIEF DESCRIPTION OF THE DRAWINGS

FIG. 1A presents a block diagram depicting a computing environment, in accordance with one embodiment of the present invention.

FIG. 1B presents a block diagram depicting a computing environment, in accordance with another embodiment of the present invention.

FIG. 2A depicts a flowchart of the operational steps taken by the credification program to verify the level of personal identification the voucher has attached to their profile and apply a reward limiter to the voucher's account within the computing environment of FIG. 1, in accordance with an embodiment of the present invention.

FIG. 2B presents a block diagram depicting composition of an account in a computing environment, in accordance with another embodiment of the present invention.

FIG. 2C depicts an image of the federated identification sources in a computing environment, in accordance with another embodiment of the present invention.

FIG. 2D presents an image of a process of registering a protocol integrator with the account in a computing environment, in accordance with another embodiment of the present invention.

FIG. 2E presents a block diagram depicting a computing environment, in accordance with another embodiment of the present invention.

FIG. 3A depicts a flowchart of the operational steps taken by the credification program to process vouching for an entity and the reward or penalty within the computing environment of FIG. 1, in accordance with an embodiment of the present invention.

FIG. 3B depicts a flowchart of the operational steps taken by the credification program to process an out-of-network event generation, vouching, and dispute resolution within the computing environment of FIG. 1, in accordance with an embodiment of the present invention.

FIG. 3C depicts the flowchart of the operational steps taken by the credification program to process bidding by vouchers in competition for a slot in the maximum number of bidders per event within the computing environment of FIG. 1, in accordance with an embodiment of the present invention.

FIG. 3D presents a block diagram depicting a computing environment, in accordance with another embodiment of the present invention.

FIG. 3E depicts a flowchart of the operational steps taken by the credification program to attest to the creditworthiness of entities engaged in borrowing within the computing environment of FIG. 1, in accordance with an embodiment of the present invention.

FIG. 4 depicts a flowchart of the operational steps taken by the credification program to implement the token protocol, within the computing environment of FIG. 1 in accordance with an embodiment of the present invention.

FIG. 5A presents a block diagram depicting a computing environment, in accordance with another embodiment of the present invention.

FIG. 6 depicts a flowchart of the operational steps taken by the credification program to process dispute resolution within the computing environment of FIG. 1, in accordance with an embodiment of the present invention.

FIG. 7 depicts a block diagram depicting the internal and external components of the server of FIG. 1, in accordance with one embodiment of the present invention.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, smart contracts, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

Embodiments of the present invention discloses a decentralized, stake-based protocol and framework for multiparty attestation of counterparty credibility.

The present invention is both a blockchain-facilitated decentralized “reputation network” protocol and a suite of web technologies that enables seamless integration of the present invention into existing commerce and lending platforms. The present invention is also an incentive-based, fraud-deterrent mechanism for establishing counterparty credibility or creditworthiness and will play an integral role in advancing a more practical alignment of participant interests in commerce and lending ecosystems, resulting in higher consumer confidence and overall levels of service quality.

The present invention's vouching mechanism is a key differentiator from existing reputation and rating and review systems in that participants have a personal stake in the outcome of the economic events involving the entity being represented. This stake is realized in the form of cryptographically secure protocol tokens. If event outcomes are positive, vouchers are rewarded with additional tokens commensurate with the amount staked. Conversely, in the event of negative outcomes, vouchers are penalized via a proportional deduction from their token balances, also known as slashing, vouching activity is limited to participants having verifiable transaction histories with parties engaged in economic activities seeking to have their credibility backed by vouchers, the process. In the context of lending vouchers will have to prove their relationship with the borrower in order to collateralize or insure their loan. Both of sees we term “credification.”

The present invention can also be incorporated and integrated into a lending system. as a form of third-party collateralization or insurance of loans. One example of such integration of the present invention can be within microfinance, and microcredit in particular, to accelerate the adoption of digital commerce. Underprivileged individuals cannot afford to lock up collateral, as a credible and secure means of preserving title to property is lacking. At the same time, the credit scoring systems that we are accustomed to using in sophisticated financial systems are not available in the developing world. In its place, trustworthy reputation systems can play a valuable role by signaling the risk of default associated with a particular individual. In particular, a standardized reputation system can incentivize the provision of capital on a peer-to-peer (P2P) basis, removing the need to rely on rent-seeking, central intermediaries as the only source of finance. Such a transaction can be administered by a smart contract that issues a reward for loan repayments and punishes any default, transferring the staked collateral to the lender to mitigate losses.

The present invention will now be described in detail with reference to the Figures.

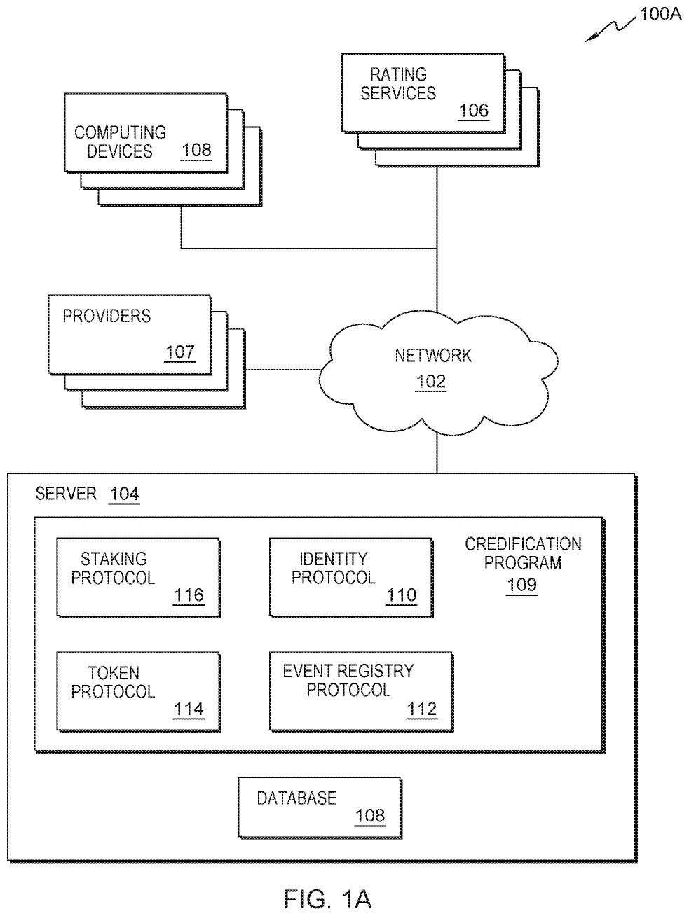

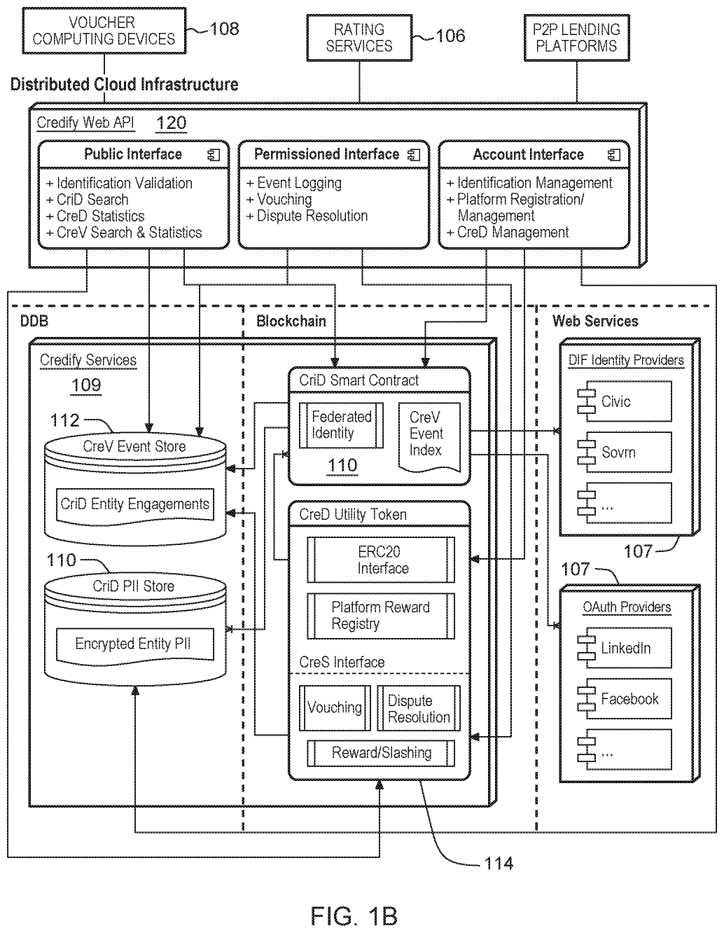

FIG. 1A depicts a block diagram depicting a computing environment 100A, in accordance with one embodiment of the present invention. FIG. 1A provides an illustration of one embodiment and does not imply any limitations regarding the environment in which different embodiments maybe implemented.

In the depicted embodiment, computing environment 100A includes network 102, server 104, rating service 106, providers 107, and computing device 109. In the depicted embodiment, server 104 container database 108 and the credification program 109. Computing environment 100A may include additional servers, computers, or other devices not shown.

Network 102 may be a local area network (LAN), a wide area network (WAN) such as the Internet, any combination thereof, or any combination of connections and protocols that can support communications between server 104, rating service 106, providers 107, and computing device 109 in accordance with embodiments of the invention. Network 102 may include wired, wireless, or fiber optic connections. The network 102 can include links using technologies such as Ethernet, 802.11, worldwide interoperability for microwave access (WiMAX), 3G, 4G, 5G, CDMA, GSM, LTE, digital subscriber line (DSL), etc. Similarly, the networking protocols used on the network 102 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 102 can be represented using technologies and/or formats including JavaScript Object Notation (JSON), hypertext markup language (HTML) and extensible markup language (XML). In addition, all or some communications channels can be encrypted using conventional encryption technologies such as secure sockets layer (SSL), transport layer security (TLS), and Internet Protocol security (IPsec).

Identity Providers 107 includes one or more third party services for identification of participants in the system. Examples of these providers 107 are various DID providers 107, OAuth providers 107, KYC providers 107, or the like. The providers 107 serve as a source for entity account information or identification data. Providers 107 can be represented by various other data sources or structures in the system, including but not limited to databases, objects, classes, meta elements, files, or any other data structure. Entities may register with the providers 107 and connect their information to their accounts within the system. The providers 107 may vary from one network to the next wherein the provider's web server, blockchains, distributed ledger, API requests, external systems, authorization, security systems, privacy systems, logging systems, and the like may be incorporated.

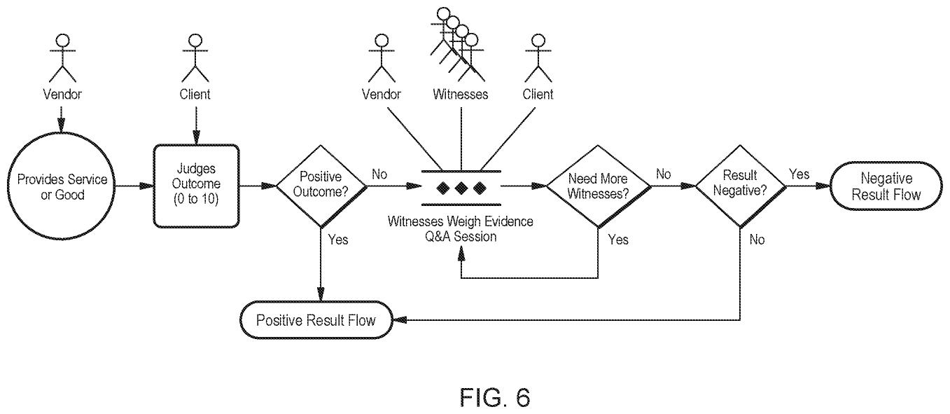

Server 104 may be a management server, a web server, or any other electronic device or computing system capable of processing program instructions and receiving and sending data. In another embodiment server 104 may be a laptop computer, tablet computer, netbook computer, personal computer (PC), a desktop computer, or any programmable electronic device capable of communicating via network 102. In one embodiment, server 104 may be a server computing system utilizing multiple computers as a server system, such as in a cloud computing environment. In one embodiment, server 104 represents a computing system utilizing clustered computers and components to act as a single pool of seamless resources. In the depicted embodiment database 108 is located on server 104., but it may be located external to server 104 Server 104 may include components, as depicted and described in further detail with respect to FIG. 6.

Computing device(s) 107 comprise one or more computing devices which is used by a voucher, entity, provider, witness, third party, or the like and transmits and receives data via network 102 in relation to the credification process. The computing device 109 may be any other electronic device or computing system capable of processing program instructions and receiving and sending data. In one embodiment, the computing device 109 is a conventional computer system executing, for example, a Microsoft Windows compatible operating system (OS), Apple OS X, and/or a Linux distribution. In another embodiment, the computing device 109 can be a device having computer functionality, such as a smart-phone, a tablet, a personal digital assistant (PDA), a mobile telephone, etc. In some embodiments, computing device 109 may be a laptop computer, tablet computer, netbook computer, personal computer (PC), a desktop computer, or any programmable electronic device capable of communicating with rating service 106 and server 104 via network 102. In other embodiments, computing device 109 may represent a server computing system utilizing multiple computers as a server system, such as in a cloud computing environment. In another embodiment, computing device 109 represents a computing system utilizing clustered computers and components to act as a single pool of seamless resources.

In one embodiment, the computing device 109 interacts with the rating service 106 through an application programming interface or credification program 109, such as iOS and Android. The computing device 109 may display content through the processing of markup language and display this information through the credification program 109. The credification program 109 displays the identified content using the format or presentation described by the markup language. Examples of the markup language are extensible markup language (XML) data, extensible hypertext markup language (XHTML) data, or other markup language data. The credification program 109 may also include the ability to process JavaScript Object Notation (JSON) data, JSON with padding (JSONP), and JavaScript data to facilitate data-interchange between the rating service 106 and the computing device 109. In other embodiments, computing device 109 may include any combination of the credification program 109, or database 108. Computing device 109 may include components, as depicted and described in further detail with respect to FIG. 6.

Credification program 109 operates to verify the vouchers, process the stakes, and process the distribution of the stakes based on the received outcomes. In the depicted embodiment, the credification program 109 utilizes network 102 to access the computing devices 107, the providers 107, and the rating service 106. In one embodiment, the credification program 109 resides on server 104. In other embodiments, the credification program 109 may be located on another server or computing device, provided the credification program 109 the computing device 109, the providers 107, and the rating service 106. In the depicted embodiment identity protocol 110, event registry protocol 112, token protocol 114, and staking protocol 116 are elements of the credification program 109. In additional embodiments, identity protocol 110, event registry protocol 112, token protocol 114, and staking protocol 116 are independent elements which communicate through network 102.

Identity protocol 110 (CriD) processes the identification registration and account management system that federates both directly provided personally identifiable information, which may or may not have been submitted, existing identity attestation protocols, and OAuth compliant identification services for the strongest possible basis of ID authenticity. In the depicted embodiment, identity protocol 110 is a function of the credification program 109. In other embodiments, the identity protocol 110 may be a stand-alone program or function located on another server, computing device, or location provided identity protocol 110 has access to the other components of the computing environment 100A.

Event registry protocol 112 (CreV) serves as a cryptographically verifiable event registration system and plays a critical role in establishing authenticity of the identity protocol 110 entity interaction. In this role, the event registry protocol 112 functions as an oracle for the token protocol 114 determination algorithm. These interactions are necessary for credification program 109 to ascertain the ability of individuals or organizations to vouch for parties seeking credification. In the depicted embodiment, event registry protocol 112 is a function of the credification program 109. In other embodiments, the event registry protocol 112 may be a stand-alone program or function located on another server, computing device, or location provided event registry protocol 112 has access to the other components of the computing environment 100A.

Token protocol 114 (CreD) is an enhanced blockchain smart contract-based utility token in one instance, or a digital asset wrapper in another, that is central to the credification program 109 vouching and incentive protocol. The smart contract may register any digitalized asset or security. In some embodiments, the digitalized asset or security may be selected by the parties or the marketplace. In additional embodiments, the digitalized assets or securities may be tethered to various other currencies (e.g. United States Dollar). In one embodiment the blockchain smart contract is Etherum™, or various other open source, public or private blockchain-based distributed computing platforms or operating systems featuring smart contract functionality. More concretely, the token protocol 114 is the currency of staking. In the depicted embodiment, token protocol 114 is a function of the credification program 109. In other embodiments, the token protocol 114 may be a stand-alone program or function located on another server, computing device, or location provided token protocol 114 has access to the other components of the computing environment 100A.

Staking protocol 116 (CreS) is a distributed service and extension of the event registry protocol 112 and connects to the program 109. Staking protocol 116 implements multiparty dispute resolution logic for peer-to-peer activity and event outcome determination. The program is responsible for staking protocol reward allocation or stake slashing dependent upon event results. In the depicted embodiment, staking protocol 116 is a function of the credification program 109. In other embodiments, the staking protocol 116 may be a stand-alone program or function located on another server, computing device, or location provided staking protocol 116 has access to the other components of the computing environment 100A.

Database 108 may be a repository that may be written to and/or read by the credification program 109, identity protocol 110, event registry protocol 112, and token protocol 114, and the staking protocol 116. In one embodiment, database 108 is a database management system (DBMS) used to allow the definition, creation, querying, update, and administration of a database(s). In some embodiments, the database 108 is a distributed ledger. In some embodiments, the database 108 is a distributed database or distributed database system. Blockchain is a data structure that stores a list of transactions and can be thought of as a distributed electronic ledger that records transactions between source identifier(s) and destination identifier(s) on database 108. The database 108 may store the data in a centralized location or distributed (decentralized) locations. The decentralized nature of the block chain can also be advantageous for certain applications, like a digital crypto-currency, as no one system or entity is the effective holder of what is “correct.” This eliminates or reduces reliance upon banks, governments, and other third parties and can result in lower transaction costs because these “middle-men” are cut out of the transaction process. In additional embodiments, the database 108 is designed to receive data from an InterPlanetary File System (IPFS). In the depicted embodiment, database 108 resides on server 104. In other embodiments, database 108 resides on another server, or another computing device, provided that database 108 is accessible to the credification program 109, identity protocol 110, event registry protocol 112, and staking protocol 114.

FIG. 1B depicts a block diagram depicting a computing environment 100B, in accordance with one embodiment of the present invention. FIG. 1B provides an illustration of one embodiment and does not imply any limitations regarding the environment in which different embodiments maybe implemented. In the depicted embodiment, the computing device 109, various types of marketplaces, and various types of P2P lending platform are in communication with the credification program 109 infrastructure. In some embodiments the marketplaces are, but not limited to, various third-party merchant marketplaces,

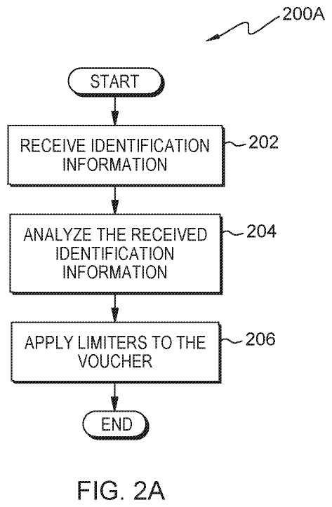

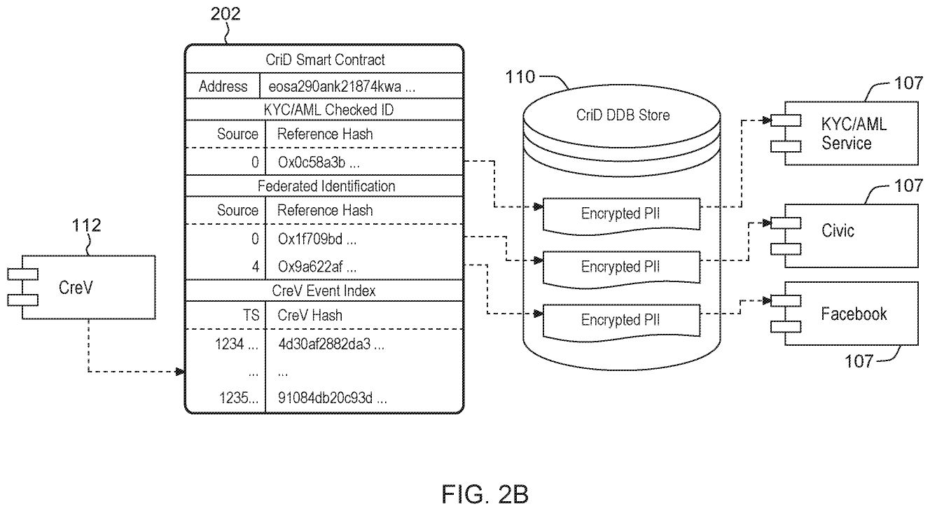

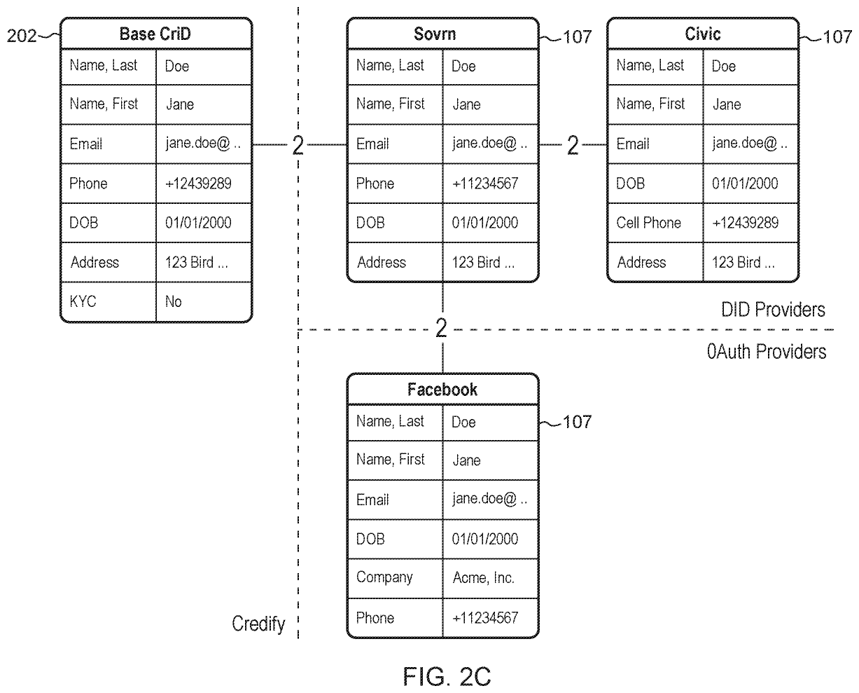

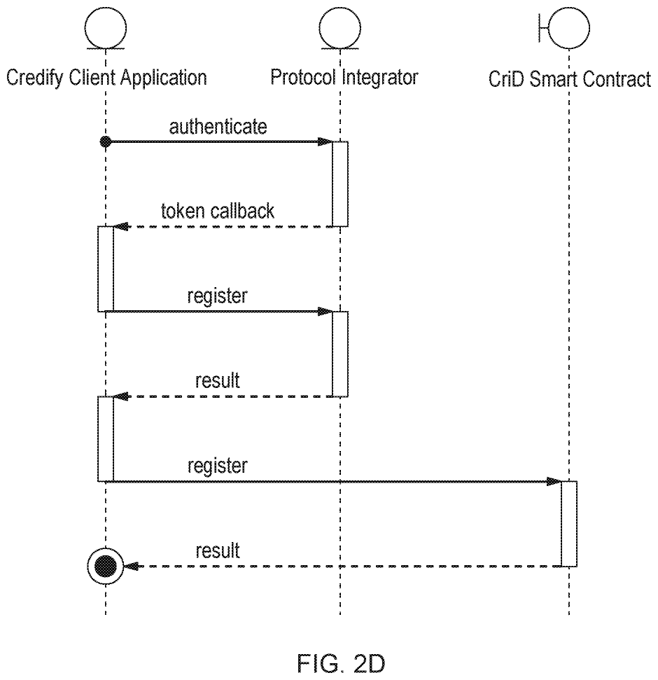

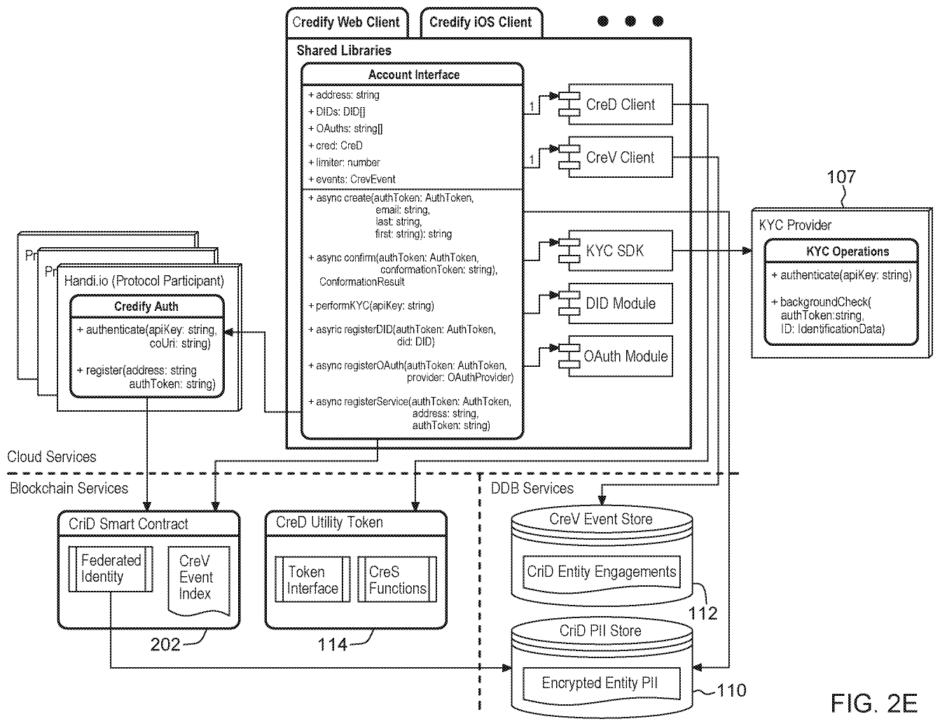

FIG. 2A depicts a flowchart 200 of a method to verify the level of personal identification the voucher has attached to their profile and apply a reward limiter to the voucher's account. The method(s) and associated process(es) are now discussed, over the course of the following paragraphs, with extensive reference to FIG. 2A, in accordance with one embodiment of the present invention.

The ability to securely establish accurate and verifiable protocol participant identities is crucial to a decentralized stake-based approach to counterparty attestation. Without such assurances, it is difficult to claim with an acceptable level of confidence that the participants are acting on their own capacity within the system. It is necessary to identify the vouchers through at least one verified and authenticated process to confirm their identity.

In step 202, the identity protocol 110 receives the voucher supplied meta-data associated with the identification information. In some embodiments, this supplied meta-data is encrypted with a voucher's private key and hashed with blockchain to protect the data and the voucher's private and personal information. The identification information may be, but not limited to government issued IDs, date of birth, phone number, address, third-party resources, profile-inclusive identity providers 107, or the like. For example, the identity protocol 110 may use, but not limited to Decentralized Identifier (DID) compliant services (e.g. Civic, Gem, and various other decentralized Identifiers based on blockchain protocols), or profile-inclusive OAuth 2.0 identity providers 107 (LinkedIn, Facebook, Line, etc.) to verify the voucher. In some embodiments, a set number of different identification sources are required to verify the voucher. In some embodiments, identity protocol 110 is able to access various sources to collect the necessary or approved identification information. In some embodiments, the personal identification information is stored in an encrypted format. In additional embodiments, the meta-data associated with the personal identification information is stored in place of the personal identification information.

In step 204, the identity protocol 110 analyzes the received meta-data associated with the identification information to determine the accuracy of the information. Through the third-party resources or services, the identity protocol 110 is able to determine the accuracy of the provided information. This verified information is stored by the identity protocol 110.

In some embodiments the post-analysis of the Personal Identifiable Information (PII) provided by the voucher will be encrypted on the client-side with the voucher's private key using, for example, the AES256 block cipher, and stored within the database 108. The data may be hashed with the blockchain protocol prior to storing. Cleartext input to the cipher for decentralized identification resources are represented by their cross-chain JSON payloads, while OAuth inputs are normalized by stripping authentication tokens and retaining available profile data. In some embodiments, the ciphertext is stored in the DDB and the digest component of the multihash identifier is indexed into the voucher smart contract. Wherein the smart contract can be a variety of different forms and types, for example, a smart contract, a split contract, or the like.

In step 206, the identity protocol 110 applies limiters to the voucher based on the received verification information. The limiters are used to encourage vouchers to supply as much identification information as possible. By imposing the limiters on the potential rewards/payouts, the vouchers are encouraged to supply more information to increase their payout/reward opportunities. Each form of identification information is associated with a limiter based on predetermined variables. In some embodiments, the limiters are modified, adjusted, altered, or reconfigured based on the type of identification information, the reputation of the identification information, and the identity protocol 110 values associated with the identification information.

For example, an initial limiter is set to 90% of the payout, meaning the voucher is only able to receive 10% of the reward/payout. In some embodiments, if the voucher supplies KYC identification information, the limiter is reduced to 50%, registration using DID further reduces an additional 15%, and providing OAuth linked accounts further reduces an additional 5%. Each form of identification information, and the source of the identification information has a predetermined limiter modifier that the voucher is able to have applied to their account. The identification information limitation is based on the credification program 109 assessment of each type of identification information. In some embodiments, identification information types are added or removed from the voucher, whereby the calculation is updated with the additional information or removal of information.

For example, an equation can, be applied to the limiters:

Limiter=90−(φ→50)∧(¬φ→0)−15α−5·(2 ∧ β)

Where φ is the conditional for KYC inclusion, α is the number of linked DIDs, β is the total of OAuth 2.0 registered accounts, limited to 2, and the result is in terms of a percentage. Depicted in FIG. 2B is an exemplary embodiment of the distribution of the identification information supplied to the identity protocol 110 that was analyzed and verified and used in the calculation of the limiter value.

In some embodiments, multiple forms of identification information are required to verify an account through the identity protocol 110. For example, a voucher may need to supply an email address, a full name, and two other Personally Identifiable Information, and at least one accounts to provide at least two matching entries with the accounts.

FIG. 2B depicts an image of the identity protocol 110 and the smart contract data associated with a voucher in accordance to the present invention. The identity protocol 110 encrypts the various PII information from the various providers 107 and services. An exemplary CriD smart contract 202 is shown.

Complementing the identity protocol 110 of the voucher smart contract is a client library that provides a set of utilities for interacting with the blockchain portion of the stack, including the voucher smart contract creation, third-party identifier registration, KYC processing, DID compliant representation of identity protocol 110 entities, protocol participant registration, and entity relationship querying.

Initial stage registration will be possible through a set of permissioned clients that interface with both the voucher smart contract and external identification providers 107. This process will later be exposed through standard authentication channels, offering the option for protocol adopters to integrate identity protocol 110 specific registration features into their normal account services.

FIG. 2C depicts an image of connection between the voucher information and the providers 107 in accordance to the present invention. In the depicted embodiment, the DID providers 107 are connected directly with the identity protocol 110, and the OAuth providers 107 are connected with the DID providers 107.

In some embodiments, various “Know your Customer” (KYC) or the like measures may be used upon registration of government issued Personal Identification Information and/or Documentation as one of many measures against parties seeking to utilize the system for money laundering operations.

FIG. 2D depicts the processing of PII information, in accordance to the present invention. Depicted in FIG. 2D, is the flow associated with third-party-supplied identity registration and handling of the PII and verification. According to the DID specification, all PII may be stored off-chain.

The identity protocol 110 request that the process send an authentication token to the provided email address. The voucher is then present this token for confirmation of the email address and the DID entity will be created on the blockchain, with PII data being encrypted by the newly generated private key and stored off-chain.

Protocol-participating platform (e.g. service marketplaces) registration is required before vouchers will be able to engage in vouching activities. Vouchers have the ability to register service platforms both through the management application and via the permissioned platforms themselves. Registration flow will be fairly straightforward, making use of standard token-based authentication and system API calls.

FIG. 2E depicts a representation of the interrelationship of the identity protocol 110 subsystems, in according to the present invention.

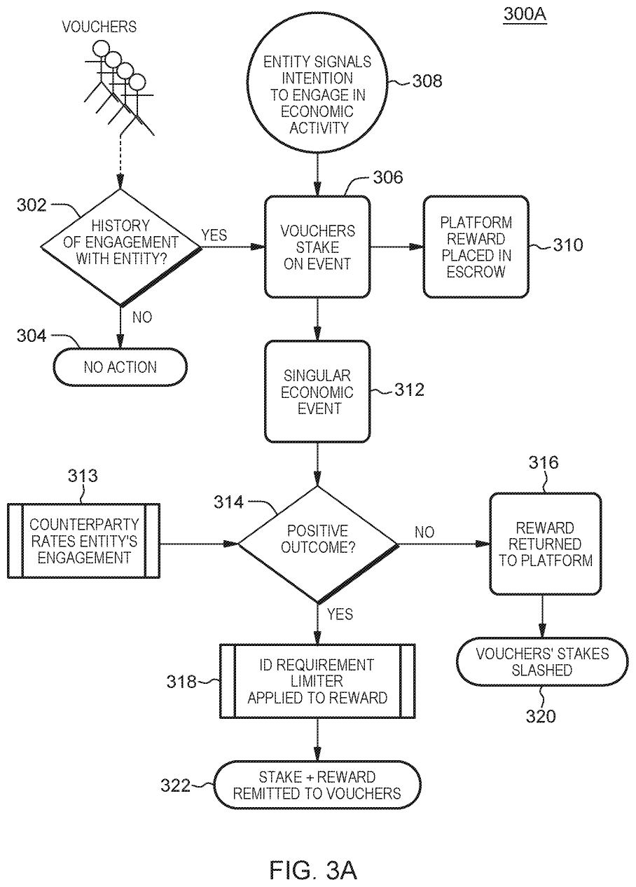

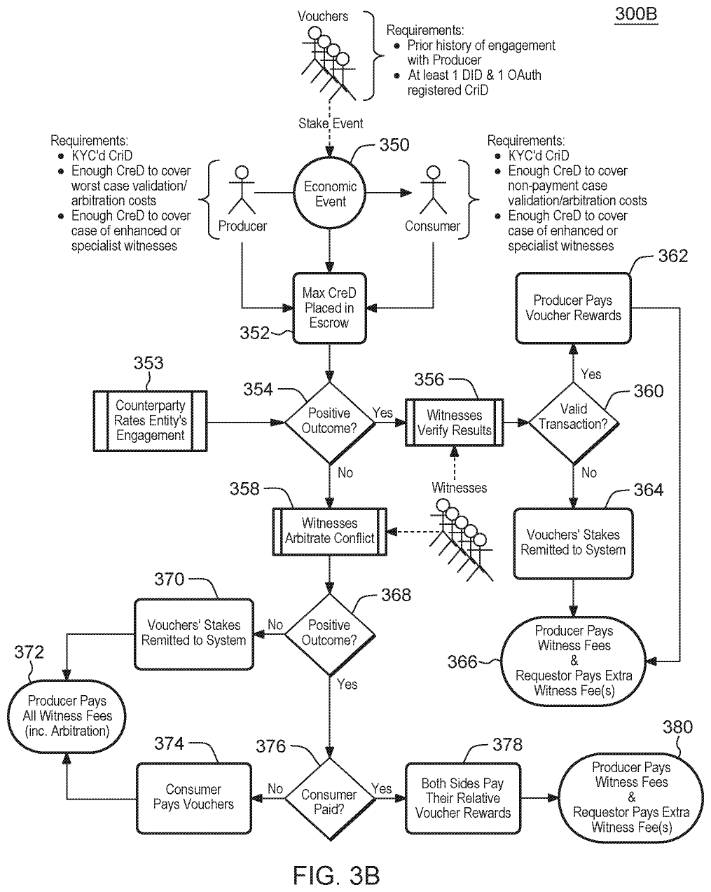

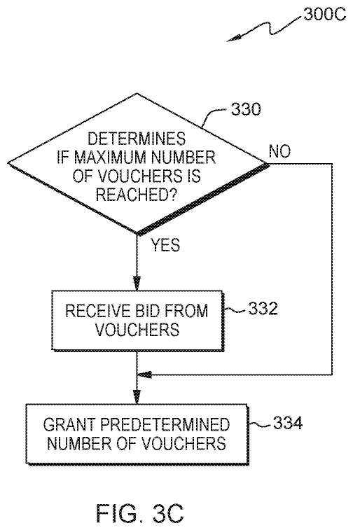

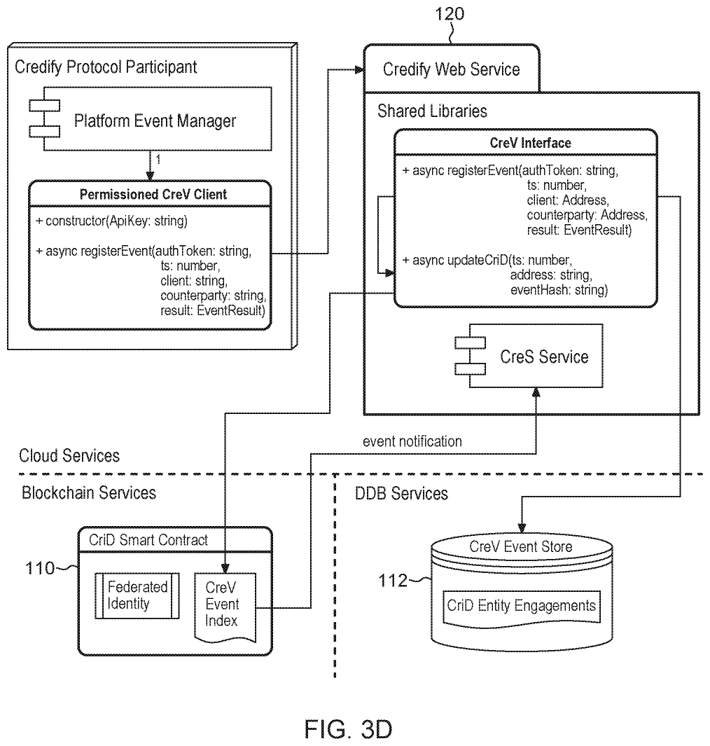

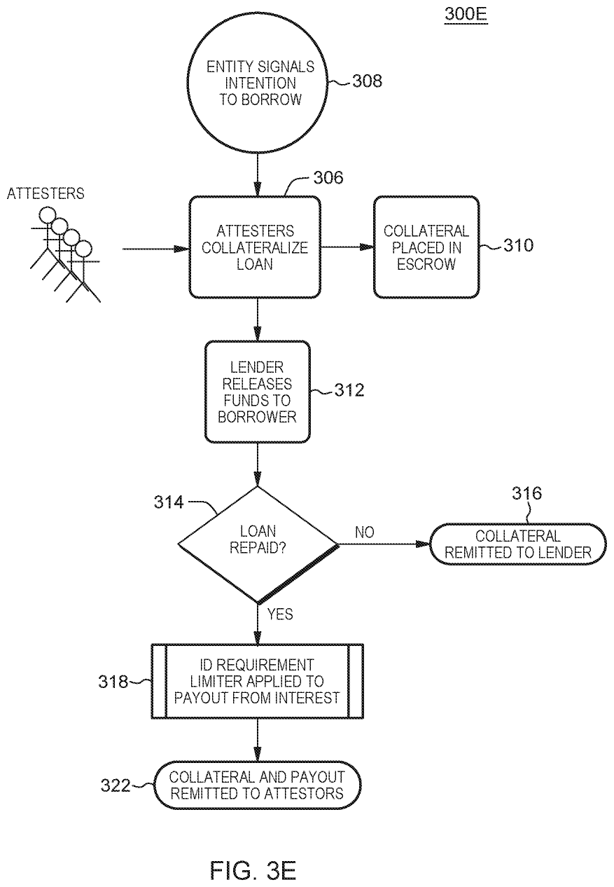

FIG. 3A depicts a flowchart 300A of a method to process vouching for an entity and the reward or penalty. The method(s) and associated process(es) are now discussed, over the course of the following paragraphs, with extensive reference to FIG. 3A, in accordance with one embodiment of the present invention.

The voucher is connected with credification program 109 to determine if a previous interaction/engagement has occurred with the voucher and the entity. This is used to confirm that the voucher has had previous relations with the entity to be vouched. If the voucher has not had any previous interactions with the entity, they are denied the ability to vouch for the entity.

If the voucher has had engagement with the entity, the voucher is able to apply a predetermined or voucher specific stake or voucher value to the entity for future engagements between the entity and third parties. In some embodiments, the entity has to verify the intention to engage in economic activities to allow for the staking/vouching to occur. Once the value of the stake is determined, the stake is placed in escrow which the entity engages in economic activities.

At the occurrence of at least one economic event, and the economic event with a third party has an outcome registered (e.g. a review), credification program 109 determines if the outcome of the economic event is positive or negative. If the outcome of the event is negative, the stake is slashed a predetermined value based on the quantity of the stake, the entity, the outcome of the economic event, and various other factors determined by the credification program 109. If the outcome of the event is positive, credification program 109 rewards the voucher with the calculated reward based on the various factors of the entity, the outcome, and voucher's status, and the stake.

Further comprising, the process for the voucher to request the ability to stake a certain entity. The stake is reviewed and determined if the voucher can vouch the entity. If the voucher is able to vouch for the entity, the voucher's reserves are analyzed to confirm sufficient quantity of assets to vouch for the entity. In some embodiments, where the voucher has insufficient assets, they can purchase additional assets or transfer assets to the platform. The assets are placed in escrow, and the voucher awaits an interaction between the entity and a third party. The interaction is analyzed upon competition to determine the outcome of the event.

The event registry protocol 112 serves as a cryptographically verifiable event registration system and plays a critical role in establishing authenticity of the identity protocol 110 entity process. In this role, the event registry protocol functions as a source for the reward/slashing protocol determination algorithm. These interactions are necessary for the event registry protocol to ascertain the ability of individuals or organizations to vouch for parties seeking certification.

In some embodiments, the event registry protocol 112 is a distributed database of economic activity, with each entry being hashed into the identity protocol 110 event index for establishing integrity of the entry data. The event registry protocol's registry includes standardized engagement and outcome histories as well as the identity protocol 110 entity vouching activity details. The event registry protocol is a permissioned service, with write access limited to approved integrators of the protocol.

The event registry protocol 112 subsystem will serve as a subscribe data source, where clients have the ability to register for updates in the event registry. This is useful for systems that rely on time-criticality of events, for instance, when activities are interdependent or chained.

As the event registry protocol 112 event registry is relied upon by the vouching portion of the smart contract for truth in entity engagement, write access is provided on a permissioned basis and is proxied through service APIs. Limiting access to approved protocol integrators ensures compliance with fair practice directives and protects against gaming the reward system by falsification of entity engagement histories.

In decision 302, the event registry protocol 112 determines if the voucher has made prior engagement with the entity. If the voucher has not had any engagement with the entity, the registry protocol stops the process (Step 304). If the voucher has had prior engagement with the entity, the registry protocol 112 permits the process to continue to the voucher vouching on an event with the entity (step 306).

After the voucher invokes the credification program 109, the platform that was specified in the invocation will be required to communicate with the registry protocol 112, which escrows the platform-specified reward from their reserves and sets the recipient of a negative outcome. In some embodiments, this defaults to the platform, but may be configured by the platform to implement redress, for example in the case of peer-to-peer credification. The reward and staking values are accessible by the credification program 109, and the party.

In some embodiments, the interaction has to be within a certain time frame from the decision. In some embodiments, the event registry protocol 112 needs to receive confirmation that the entity is or has intention to engage in economic activity (Step 308).

In some embodiments, the voucher is permitted the ability to adjust the value, quantity, currency, or the like regarding the vouching activities (stakes). In some embodiments, the factors associated with the vouching is predetermined by the marketplace or determined prior to activating the vouching activities.

In step 310, the event registry protocol 112 places the voucher amount or data in an escrow or secure location while the engagement is active. This is to securely and safely maintain the digital assets while the relationship is active. In some embodiments, the reward is placed in escrow or in a secure location.

In step 312, the event registry protocol 112 receives economic event registration between the voucher and the entity which the voucher intends or desires to vouch for. The event may have previously occurred or currently occurring. In some embodiments, event registry protocol 112 is provided with previous events between the voucher and the entity.

In decision 314, event registry protocol 112 processes an event outcome between a third party and the entity. This processing is to determine if the event was positive or negative. The positivity or the negativity of the event may be recorded in various methods or processes dependent upon the platform or system used to record the interaction between the third party and the entity (step 313). The event has occurred within a predetermined time period of the voucher backing the entity. In some embodiments, the event occurs after the voucher has backed the entity. In additional embodiments, the reward has to process prior to the event occurring. If the event outcome is positive (YES branch, proceed to step 318), the event registry protocol 112 the limited is applied to the reward. If the event outcome is negative (No branch, proceed to step 316), the event registry protocol 112 returns the reward to the platform.

In a specific embodiment, the entries are: nonce is used to protect against double entries; tts is an ANSI ASC X.995 trusted timestamp of the event issued by a Trusted Timestamp Authority; platform is the address of the protocol integrating platform on which the event took place; outcome is a bit field that encodes information about the event result, with the minimum requirement of a) the first four being set from 0b0000 to 0b1010 to represent a scaled result score from 0 to 10 as a conclusion to the engagement, with 5 being neutral, <5 being negative and >5 positive, and b) the fifth bit being set to 0 or 1 to specify whether or not the event outcome was contested—this field is extensible to allow for inclusion of platform-specific information, such as whether or not the client paid for the good or service, as might be the case with peer-to-peer events; reason is a bit field representing categories of causes for a negative (<5) result to be defined and expanded as protocol adoption grows; vouchers is the list of addresses of the vouching entities, if any; and witnesses is an optional list of at least three randomly selected dispute resolution arbitrators provided to integrators missing their own internal processes for dispute resolution.

In step 316, the event registry protocol 112 returns the reward to the platform. Where the event outcome was determined to be negative. The event registry protocol 112 returns the reward to the platform. In some embodiments, the negative rating is able to be contests (FIG. 3B). When the reward is returned to the platform, the vouchers stakes are slashed based on the value of the reward amount. In some embodiments, the vouchers limiter value is applied to the returned reward.

In step 318, the event registry protocol 112 processes the reward. The reward is adjusted based on the limiter value calculated identity protocol 110. The reward is adjusted based on this limiter value. Once the reward is processed and adjusted by the limiter value associated with the voucher, the modified reward value is remitted to the voucher (step 322).

In some embodiments, the even outcome is processed within a set time period after the feedback of the entity has been submitted. In additional embodiments, a snapshot of the feedback is retained through the processing stages.

Once it is determined by the voucher, that they had terminated the vouching relationship with the entity. The event registry protocol 112 remits the stakes and rewards (or loses) to the voucher (step 322).

FIG. 3E depicts a flowchart 300E of a method to attest to the creditworthiness of entities engaged in borrowing within the computing environment of FIG. 1, in accordance with an embodiment of the present invention. The depicted embodiment expresses an additional environment where the present system may be implemented. The present system can be implemented in a multitude of interactions between persons and entities.

The depicted embodiment relates to providing a loan and attesting the likelihood that the person or entity will repay the loan. In the depicted embodiment, a lender releases the funds to a borrower, and an attester (or voucher) attests to the collateralized loan (step 306). Collateral is placed in escrow (step 310) based on the platform design. In some embodiments, the platform maintains the collateral. In additional embodiments, a third party maintains the collateral. The funds are released to the borrower (step 312), and the event registry protocol 112 monitors the loan, to determine if the loan was repaid or is being repaid. The repayment of the loan may be within a predetermined time period, paid off to a certain percentage at a specific date or time, or various other milestones which can occur with the repayment of a loan. If the loan repayment is not accomplished (step 316), the collateral is remitted to the lender. In some embodiments, a portion of the collateral is returned to the attester based on the platform design and any predetermined agreements between the platform and the attester. If the loan is repaid within the requirements, the attester(s) receive their collateral plus a payout (step 318). Wherein the payout is based on attestor, the entity, the loan, the loan requirements, and additional factors associated with the parties involved.

FIG. 3B depicts a flowchart 300B of a method to process a dispute resolution. The method(s) and associated process(es) are now discussed, over the course of the following paragraphs, with extensive reference to FIG. 3B, in accordance with one embodiment of the present invention.

In some embodiments, the event registry protocol 112 is accessible to platforms lacking payment processing support, like Craigslist™ or Gumtree™, a special-purpose application and service will be provided that will enable “out-of-network” event registration into the event registry protocol 112. In these “out-of-network” embodiments, there are additional requirements which need to be accomplished to reward or stake the digital assets. In the depicted embodiment, an economic event (350) occurs between a producer, a consumer and a voucher, who is attesting to a positive resolution of the economic event by vouching their digital assets on the outcome of this event. In some embodiments, each of the voucher, producer, and consumer have to undergo the procedure performed by the identity protocol 110.The vouching payouts, in this embodiment, are the responsibility of the producer, unless the consumer fails to meet the financial obligation of the transaction, in which case the reward will be deducted from the consumer's escrow. Both the producer, consumer, and voucher place a quantity of the digital asset in escrow (step 352). In some embodiments, these values may all be substantially identical, or may be based on the limiter value calculated by the identity protocol 110. After the economic event (step 350) occurs, the event registry protocol 112 determines if the outcome of the event was positive or negative (decision 354). This outcome is determined by a counterparty (e.g. the consumer, producer, or a third party) rating the event (353).

If the outcome of the event is positive, at least one witness verifies the results of the event (step 356). The witness are individuals or entities which were present to at least part of the economic event. In some embodiments, Each event outcome is signed off by the majority of three randomly selected “witnesses”; In order to participate as a witness, an entity is required to have registered at least one DID and one OAuth identity; Additionally, witnesses will be required to deposit an amount of the event registry protocol 112 to be later determined with the out-of-network smart contract that acts as a “security deposit” against automated voting. If a witness is discovered to exhibit a pattern of unacceptable behavior, the deposit will be slashed and they will lose witness privileges for one year; When necessary, witnesses will be required to participate in a dispute resolution process, where both parties present their cases and the witnesses vote on based on the cases presented. The majority vote amongst the witnesses determines the outcome. Once an outcome has been reached, the witnesses receive their payout for their involvement in the arbitration or meeting process. In some embodiments, a maximum possible payout must be placed in escrow by both parties before credification can commence.

In some embodiments, the witness is randomly selected based on a witness random-selection algorithm will incorporate a weighting system that increases the likelihood of being chosen based upon the witness's limiter calculation performed by the identity protocol 110.

The witnesses are neutral parties to the economic event which are brought into either testify as to subject matter related to the economic event, or to review evidence or testimony brought forth by the parties. In some embodiments, witnesses are members of the platform or are employees of the platform. In some embodiments, witnesses are incentivized to participate in the program via compensation of the event registry protocol 112 for approvals and conflict resolution arbitration. In one embodiment, the compensation for the witnesses are fixed for approvals/arbitration and, subject to the same conditions as the reward, will be the responsibility of the engaging parties. In additional embodiments, the compensation for the witnesses is proportionate to various factors associated with the witness and the economic event, as well as the responsibility to compensate the witnesses is determined by the parties involved.

If the outcome of the economic event is not positive, the witnesses are used to arbitrate (step 358) the conflict to reach a resolution. In some embodiments, the arbitration will be performed via a special-purpose application and/or web interface provided by a third party that will include Q&A session capabilities, where each party presents their case with supporting evidence, like product or situational photography or other pertinent documentation. If it is determined that from the arbitration that a positive outcome was achieved in the economic event, it is determined if the consumer paid for the economic event (decision 376). If the consumer did pay, the producer, the consumer pays their portion of the reward to the voucher (step 378) and the witnesses are compensated (step 380). If it determined that the consumer has not paid for the economic event, within a predetermined time period. The consumer pays the voucher (step 374) and the producer pays the witnesses for their involvement in the arbitration (372). The producer is also responsible for the payment of the witness's involvement with the arbitration if, the arbitration does not determine that a positive outcome of the economic event was achieved. In this situation, the voucher's digital assets are remitted to the system (Step 370).

In addition to an embodiment, where there are three witnesses, either party has the option to request additional, more strictly verified witnesses in even number increments to avoid draw scenarios upon arbitration. In order to request additional witnesses, the event registry protocol 112 based fee will be levied against the requesting party, and to avoid abuse of this system, the number or additional witnesses is capped at 7.

In additional embodiments a vetting procedure for specialist witnesses to be available for more accurate dispute resolution in cases where domain specific knowledge is required.

In some embodiments, credification program 109 is subject to RMA and “cool-off” regulations regarding return of goods or reimbursements in certain jurisdictions, protocol implementers can delay notifying of events until the required “cool-off” period expires. Delaying results will result in all parties' stakes being locked in the system for the duration of the delay, so we encourage platforms to prompt vouchers for resolution during the period.

FIG. 3C depicts a flowchart 300C of a method to process bidding by vouchers in competition for a slot in the maximum number of bidders per event. The method(s) and associated process(es) are now discussed, over the course of the following paragraphs, with extensive reference to FIG. 3B, in accordance with one embodiment of the present invention.

In decision 330, the event registry protocol 112 determines if the maximum number of vouchers has been reached. In some situations, a certain entity or marketplace may only permit a set number of vouchers to vouch for an entity. In the event where more than this preset maximum number of vouchers is reached, the event registry protocol 112 activates a process to determine which vouchers are granted the privilege to vouch for the entity. If the event registry protocol 112 determines that more than the maximum number of vouchers is reached (YES branch, proceed to step 306), the event registry protocol 112 requests a bid from each of the vouchers. If the event registry protocol 112 determines that more than the maximum number of vouchers is reached (NO branch, proceed to step 308), the event registry protocol 112 process the event outcome with the vouchers.

In step 332, the event registry protocol 112 requests a bid from each of the vouchers. The bid is any predetermined action which needs to be received from the voucher. This may include a bid, wherein the highest set number of bids win and are allowed to vouch for the entity. In some embodiments, this may be a monetary bid, wherein a predetermined number of vouchers with the highest bid are granted the right to vouch the entity. In some embodiments, the vouchers may have to bid a predetermined value to vouch for the entity. Various types of bidding processes may be implemented by the credification program 109, the marketplace, or the voucher.

In step 334, the event registry protocol 112 grants the predetermined or selected vouchers the ability to vouch for the entity. Through the event registry protocol 112 the vouching activities are engaged for the voucher within the specific marketplace and the predetermined entity(ies). In some embodiments, the voucher is provided with a notification that they are engaged with the vouching activities with the entity.

FIG. 3D presents a block diagram depicting a computing environment, in accordance with another embodiment of the present invention. The method(s) and associated process(es) are now discussed, over the course of the following paragraphs, with extensive reference to FIG. 3D, in accordance with one embodiment of the present invention.

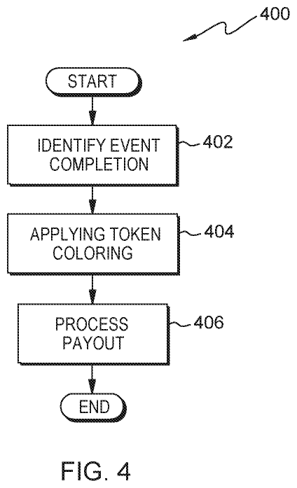

FIG. 4 depicts a flowchart 400 of a method of the token protocol 114, in according to the present invention. The method(s) and associated process(es) are now discussed, over the course of the following paragraphs, with extensive reference to FIG. 4, in accordance with one embodiment of the present invention.

Instrumental to meeting both the incentive and cost requirements the token protocol 114 implements a token application process to the reward or staking based on the outcome of the event. The token protocol 114 identifies when an event has been completed (step 402) and identifies the parties involved. The event may be the rating, the loan repay amount, or any action which a voucher or attestor has “backed” the event.

The token protocol 114 identifies the parties involved in the event and assess if a party has additional digital assets to apply to the transactions. In some embodiments, a platform may have platform-specific incentive programs (e.g. loyalty points, discount coupons, etc.) which it may wish to have applied to the payout. The token protocol 114 applies (step 404) these additional digital assets to the payout through “coloring” the digital asset. This feature establishes strong motivation for frequent and honest network participation. Platform-specific rewards are implemented by extending the smart contract implementation of tokens with a mapping of unique identifiers to the number of tokens having been colored for their purpose.

In some embodiments, the tokens are staked and locked during vouching and dispute resolution, are distributed or slashed as a result of vouching outcomes and are the unit of witness settlement in the out-of-network event registration and dispute resolution protocol. To achieve this broad scope of utility, the token protocol 114 further extends the base token with special escrow features.

In one embodiment, the smart contract defines a function for platform registration by the smart contract owner and the platform modifier that restricts reward coloring capabilities to a permissioned and registered platform. The token protocol 114 then processes the payout (step 406) with the applied data, information, or incentives.

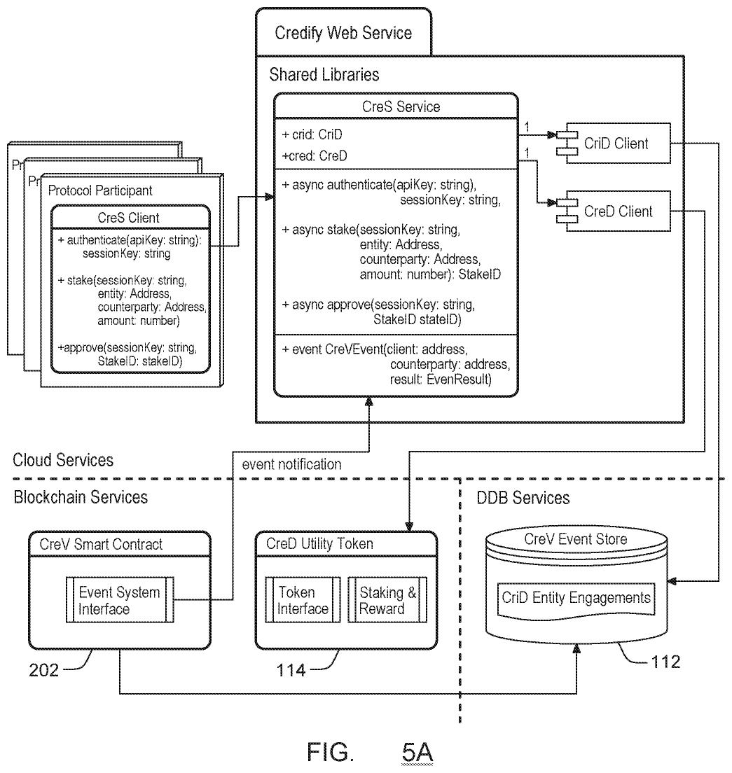

FIG. 5B presents a block diagram depicting a computing environment, in accordance with another embodiment of the present invention.

The set of smart contracts and services that comprise the staking protocol 116 reach across the protocol's functional domains, thus requiring an extra level of consideration with regard to security implications of their design. The staking protocol 116 is implemented as a permissioned service, where end vouchers interface with the service via protocol-participating platforms or the present system's out-of-network credification feature. Communication with the staking protocol 116 distributed web service employs TLS, where the system implements an internal CA for the main service endpoint, expand to standard CAs for end vouchers and employ JSON Web Tokens for API-level session authentication.

The act of vouching requires the voucher to initiate the sequence by communicating with the staking protocol 116 with a SHA-3 ECDSA message signed with their private key and includes a secure timestamp, which is followed by the protocol integrating platform approving of the vouch with a similar call into the staking protocol.

All smart contract calls related to the vouching system are marshalled through the distributed service interface, and actual invocation requires private-key delegate, or proxy, signed messages to interact with the smart contract.

The program's 109 key management incorporates a procedural protocol that implements the Encryption Key Management Standard and includes multisig encryption and storage on DDB certified Hardware Security Modules.

The staking protocol 116 is subject to, but not limited to, the following conditions: Only entities possessing proven transactional histories with the counterparty can participate; The action of staking escrows voucher's stake in the system wallet for the duration of the event and ties it to the same, meaning one cannot vouch multiple times simultaneously on the same event or on other event with the same staking protocol; the staking protocol rewards are placed in escrow from protocol integrator's reserves. If reserves are insufficient, integrator procure more staking protocol 116 to meet minimum reserve requirements. The number of vouchers per event can be capped by the integrating platform. Stake amounts are restrictable per the integrating platform's requirements. In some embodiments, the vouchers need to bid or supersede other vouchers through varies metrics or actions.

These specifications offer flexibility to protocol integrators that gives them the levers necessary to strike a balance between the value of the credification program 109 and the cost of protocol participation.

Limiting vouching to entities with proven transactional histories is a measure taken in conjunction with the identity protocol 110 limiter to insure against the “click farm” class of exploits, effectively increasing the economic cost beyond the potential value that any activity may generate.

As outlined above, the system offers flexibility in the staking protocol 116 by allowing implementers to configure both the max number of vouchers and limits to the amounts entities can stake. Doing so, one can strike the proper balance of risk-reward incentives for their specific platform requirements.

For example, a platform may wish to implement voucher competition with the intent to encourage stronger signaling of confidence in a counterparty. In such a case, the implementer might set the maximum number of vouchers to 5 per event, but uncap amounts staked. Doing so would create a competitive environment that motivates deeper consideration of counterparty credibility as participants vie for a limited number of voucher slots by increasing their intended stakes.

Limiting the number of vouchers could also prove particularly helpful in ensuring those willing to take the most risk on the credibility of a counterparty are guaranteed a reward that justifies the exposure, as opposed to having rewards spread too thin amongst a cadre of vouchers.

The staking protocol 116 is designed to allow maximum flexibility on the part of protocol integrators. Payout percentages are dynamically configurable by integrators on a per-event basis at the time of vouching. This approach is preferable to a fixed reward system as it allows integrators to adjust for the market price of the staking protocol and keep payouts within margins that will optimize the cost-utility function. This function takes on the following form:

u(C)=ΔP−C

Where is the additional benefit derived from integrating the protocol ΔP for instance, higher profit margins due to increased platform engagement, reduced costs associated with reduction of defaults, RMA and disputes, etc.—, and C is the total cost of participation in terms of per-transaction outlays, maybe calculated by the following equations:

C=Σ Cₜₓₙ

C=max{Λ, Cₜₓₙ}+Σⱼ₌₀^{3+α}^{ᵥ}wⱼ+Σsᵥ

Where λ is the max vouch configured by the protocol integrator, κ is the amount of staking protocol vouched, τ is the acquisition cost of staking protocol at time τ i of vouching, and p is the payout percentage for vouch i restricted by the voucher's reward limiter l. It is important to consider that voucher participation is incentivized by vouching rewards, ergo setting too low will have the negative consequence of insufficiently incentivizing participation and will ultimately drag on the protocol's total utility.

In one embodiment, the rewards for peer-to-peer transaction credification will be governed by the same cost-utility function presented above, but the cost equation is augmented to account for witness payouts, as follows:

Cₜₓₙ=Σᵢ max{λ, κᵢ}τᵢpᵢ(1−lᵢ)

Where i is the voucher index for the vendor (v) side of the transaction, Λ is the max payout limiter, w are the witnesses, possibly increased by α, and s are the specialists added by the vendor. In this case, both p and l of Ctxn are configured by the vendor. The Λ cap on total reward payouts is dynamically imposed by CreS as a restrictionary measure to safeguard the network against rogue actors that might attempt to exploit the protocol for money laundering purposes. This value will be derived as one sample standard deviation from the estimated mean over the previous 12-month random sample of aggregate marketplace rewards payouts (p), calculated.

A smart contract is a program that is able to govern the relationship between two or more parties by executing and enforcing the terms that have been embedded in the code. As a result, smart contracts have primarily come to be associated with DLT networks. These networks have enabled smart contract s to escrow digital assets and data on behalf of other parties, thereby facilitating the execution of verifiable, state-contingent transfers of value. When smart contract s function as intended, the algorithmic execution of the agreement can reduce administrative errors, prevent malicious interventions and remove the problems associated with the ambiguity of natural language (and human judgment). This comes from a desire to minimize the transaction costs that are inherent in conventional smart contract processes, including the costs derived from manual performance, the high litigation fees that may bar access to justice and the potential unpredictability of court judgments.

The staking protocol 116 advocates that the marketplace make use of split smart contracts for commercial transactions. A split contract is an agreement that can be executed or enforced in part by both natural language and smart contract code, thereby combining the strengths of each medium of expression. While the natural language and the code may refer to the same obligations, it is also possible to allow each medium to cover a specific part of the smart contract.

At the macro level, marketplaces can embed their pre-existing terms and services into the smart contract code by way of a hash. By way of analogy, the blockchain protocol requires vouchers to attach a hash of the network's constitution to every transaction to indicate that the vouchers are willing to abide by its terms. Within the smart contract, marketplaces can also include a pointer to an external source of information where the terms and conditions are found. Along with token coloring, split contracts form part of the governance and customization procedures that the program 109 aims to provide for marketplaces.

At the micro level, marketplaces can also allow transacting parties to use split contracts. This will allow parties to specify what they aim to achieve by transacting with one another, as well as including other provisions that cannot be encoded. To facilitate this process, marketplaces could create natural language templates for different use cases and map these to the corresponding smart contract s. In doing so, marketplaces would also allow non-programmers to enter into transactions with greater confidence. Should any bugs, attacks or disputes materialize, the prescribed arbitrators could then interpret the parties' intentions be reference to the natural language and resolve the dispute accordingly.

It is no coincidence that the program 109 is building its platform on the various blockchain protocols. Apart from being far more scalable than its competitors, the blockchain protocol allows vouchers to embed natural language into a smart contract as meta-data. Further, blockchain protocols have an in-built arbitration system that parties can resort to as a default dispute resolution mechanism. These arbitrators are accustomed to interpreting split contracts and are likely to face pressure from the blockchain protocol community to adjudicate in a reasonable manner.

FIG. 6 depicts a flowchart of a method to dispute resolution, in according to the present invention. Dispute resolution is the responsibility of the protocol integrator, but the credification program 109 witness-based dispute resolution feature will be made available as an option for platforms that lack this capability and as part of the peer-to-peer

In embodiments, where witnesses are required based on a negative outcome of an economic event. Witnesses are provided with evidence related to the economic event to provide evidence and additional information about the economic event. Through a session or meeting, the witnesses, a vendor offering the goods or services, and the client who received the goods or services evidence is submitted. If during this session or meeting, it is determined if additional witnesses are needed to provide relevant and needed evidence or information. These additional witnesses are gathered and incorporated into the session or meeting. If ample evidence is brought, or both the client and vendor do not have any further evidence or witnesses. A determination is made as to whether the outcome shall remain negative or shall be converted to a positive outcome. Based on this determination the economic event proceeds with the selected flow and rewards or stakes are applied to the voucher's digital assets.

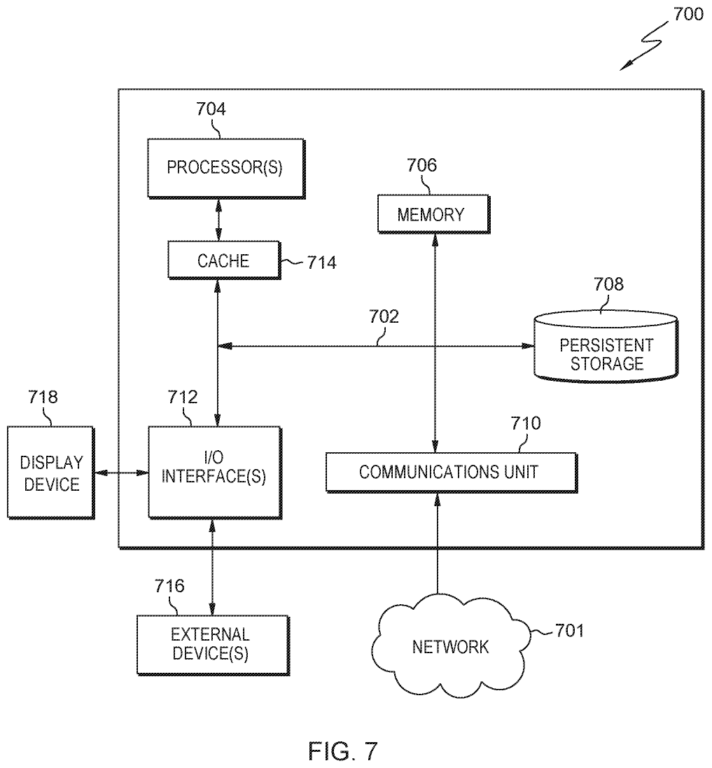

FIG. 7 depicts a block diagram 700 of components of a computing device 109, in accordance with an illustrative embodiment of the present invention. It should be appreciated that FIG. 1 provides only an illustration of one implementation and does not imply any limitations with regard to the environments in which different embodiments may be implemented. Many modifications to the depicted environment may be made. It should be appreciated FIG. 1 provides only an illustration of one implementation and does not imply any limitations with regard to the environments in which different embodiments may be implemented.

Computing environment 700 is, in many respects, representative of the various computer subsystem(s) in the present invention. Accordingly, several portions of computing environment 700 will now be discussed in the following paragraphs.

Computing device 700 includes communications fabric 702, which provides communications between computer processor(s) 704, memory 706, persistent storage 708, communications unit 710, and input/output (I/O) interface(s) 712. Communications fabric 702 can be implemented with any architecture designed for passing data and/or control information between processors (such as microprocessors, communications and network processors, etc.), system memory, peripheral devices, and any additional hardware components within a system. For example, communications fabric 702 can be implemented with one or more buses.

Computing device 700 is capable of communicating with other computer subsystems via network 701. Network 701 can be, for example, a local area network (LAN), a wide area network (WAN) such as the Internet, or a combination of the two, and can include wired, wireless, or fiber optic connections. In general, network 701 can be any combination of connections and protocols that will support communications between computing device 700 and other computing devices.

Memory 706 and persistent storage 708 are computer-readable storage media. In one embodiment, memory 706 includes random access memory (RAM) and cache memory 714. In general, memory 706 can include any suitable volatile or non-volatile computer-readable storage media.

Memory 706 is stored for execution by one or more of the respective computer processors 704 of computing device 700 via one or more memories of memory 706 of computing device 700. In the depicted embodiment, persistent storage 708 includes a magnetic hard disk drive. Alternatively, or in addition to a magnetic hard disk drive, persistent storage 708 can include a solid-state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 710, in the examples, provides for communications with other data processing systems or devices, including computing device 700. In the examples, communications unit 710 includes one or more network interface cards. Communications unit 710 may provide communications through the use of either or both physical and wireless communications links.

I/O interface(s) 712 allows for input and output of data with other devices that may be connected to computing device 700. For example, I/O interface 712 may provide a connection to external devices 716 such as a keyboard, keypad, camera, a touch screen, and/or some other suitable input device. External devices 716 can also include portable computer-readable storage media such as, for example, thumb drives, portable optical or magnetic disks, and memory cards. Software and data used to practice embodiments of the present invention, e.g., regulation program 420 can be stored on such portable computer-readable storage media and can be loaded onto persistent storage 708 of computing device 700 via I/O interface(s) 712 of computing device 700. Software and data used to practice embodiments of the present invention can be stored on such portable computer-readable storage media and can be loaded onto persistent storage 708 of computing device 700 via I/O interface(s) 712 of computing device 700. I/O interface(s) 712 also connect to a display 718.

Display 718 provides a mechanism to display data to a voucher and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the voucher's computer, partly on the voucher's computer, as a stand-alone software package, partly on the voucher's computer and partly on a remote computer or entirely on the remote computer or server. In the latter scenario, the remote computer may be connected to the voucher's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

What is claimed is:

1. A method of attesting to the credibility of entities engaged in commerce and trade, utilizing a value-staked vouching mechanism wherein backing positive outcomes results in economic rewards for attesters and, conversely, backing negative outcomes results in economic penalties for the same, the method:
creating, by one or more processors, an account on a distributed secure ledger;
associating, by one or more processors, at least one personal identification information datum to the account;
assigning, by one or more processors, a limiter value based on the type of the personal identification information data associated with the account;
receiving, by one or more processors, a request from the account to attest to an entity's credibility, wherein the account has at least on documented prior engagement or a verified connection with the entity;
assigning, by one or more processors, the account to attest to the entity's credibility or creditworthiness by staking on their activity, wherein the assignment places at least a portion of a tokenized asset in digital escrow, wherein the tokenized asset is associated with the account;
receiving, by one or more processors, a rating by a third party of an engagement between the third party and the entity;
analyzing, by one or more processors, the rating of the entity by the third party; and
adjusting, by one or more processors, the first portion of the tokenized asset associated with the account with a second portion of the tokenized asset based on the analyzed rating of the third party.

2. The method of claim 1, wherein the adjustment of the first portion of the tokenized asset further comprising, adjusting the second portion of the tokenized asset based on the limiter value assigned to the account.

3. The method of claim 1, wherein, the various types of personal identification information data have predetermined limiter values associated with each type of personal identification information.

4. The method of claim 1, wherein a predetermined number of accounts are permitted to be assigned to the entity for attestation.

5. The method of claim 1, further comprising creating, by one more processorprocessor, a smart contract functionality assigned to the first quantity of the tokenized assets associated with the account.

6. The method of claim 4, wherein the smart contract functionality is a blockchain based distributed computing platform.

7. The method of claim 1, wherein the analyzed rating of the entity, further comprising, processing, by one or more processors, a dispute resolution procedure brought by the account based on the analyzed rating of the entity.

8. The method of claim 1, further comprising, receiving, by one or more processors, a request for a payout to the account.

9. The method of claim 7, wherein the payout is calculated based on the summation of the first portion of the tokenized asset and the second portion of tokenized assets of determined by ratings of the entity while the account was assigned to attest the entity credibility.

10. The method of claim 1, wherein the personal identification information is encrypted with an entity's private key, stored on a distributed data store or database and hashed into the smart contract account on a distributed and cryptographically secure ledger.

11. The method of claim 1, wherein the rating of the entity is processed along a scale to determine the categorization of the rating.

12. The method of claim 4, wherein if the number of accounts exceeds the predetermined number, a selection protocol of the accounts is initiated

13. The method of claim 12, wherein the selection protocol, further comprising, receiving, by one or more processors, a bid from each account

14. The method of claim 13, wherein the predetermined number of accounts with the highest bids are selected, by one or more processors, to attest to the entity.

15. The method of claim 1, further comprising, processing, by one or more processors, the rating to determine if the rating adheres to set of requirements to qualify as a valid rating.

16. A computer program product for attesting to a voucher and processing a rating, the computer program product comprising:
one or more computer readable storage media and program instructions stored on the one or more computer readable storage media, the program instructions comprising:
program instructions to create an account on a distributed secure ledger;
program instructions to associate at least one personal identification information datum to the account;
program instructions to assign a limiter value based on the type of the personal identification information data associated with the account;
program instructions to receive a request from an account to attest to an entity's credibility, wherein the account has at least one documented prior engagement or a verified connection with the entity;
program instructions to assign the account to attest to the entity's credibility or creditworthiness by staking on their activity, wherein the assignment places a first portion of a tokenized asset in digital escrow, wherein the tokenized asset is associated with the account;
program instructions to receive a rating by a third party of an engagement between the third party and the entity;
program instructions to analyze the rating of the entity by the third party; and
program instructions to adjust the first portion of the tokenized asset associated with the account with a second portion of the tokenized asset based on the analyzed rating of the third party.

17. The computer program product of claim 15, wherein, the various types of personal identification information data have predetermined limiter values associated with them.

18. A computer program product of attesting to the creditworthiness of entities engaged in borrowing, utilizing a stake-based collateralization or insurance mechanism wherein backing borrowers that service loans according to contractual repayment terms results in economic rewards for attesters and, conversely, backing borrowers that fail to service loans according to contractual obligations results in the backers' collateral being remitted to the lender as a form of redress, the computer program product comprising:
one or more computer processors, one or more computer readable storage media, and program instructions stored on the one or more computer readable storage media for execution by, at least one of the one or more processors, the program instructions comprising:
program instructions to create an account on a distributed secure ledger;
program instructions to associate at least one personal identification information datum to the account;
program instructions to assign a limiter value based on the type of the personal identification information data associated with the account;
program instructions to receive a request from an account to attest to an entity's credibility, wherein the account has at least one documented prior engagement or a verified connection with the entity;
program instructions to assign the account to attest to the entity's credibility or creditworthiness by staking on their activity, wherein the assignment places a first portion of a tokenized asset in digital escrow, wherein the tokenized asset is associated with the account;
program instructions to receive a rating by a third party of an engagement between the third party and the entity;
program instructions to analyze the rating of the entity by the third party; and
program instructions to adjust the first portion of the tokenized asset associated with the account with a second portion of the tokenized asset based on the analyzed rating of the third party.

19. The computer system of claim 18, wherein, the various types of personal identification information data have predetermined limiter values associated with them.

20. The computer system of claim 18, wherein a predetermined number of accounts are permitted to be assigned to the entity for attestation.
